(19) United States
(12) Patent Application Publication
(10) Pub. No.: US 2009/0307312 A1
(43) Pub. Date: Dec. 10, 2009

(54) System and Method for Signaling and Media Protocol for Multi-Channel Recording

(75) Inventor: Veeru Ramaswamy, Jackson, NJ (US)

Correspondence Address: STOLL KEENON OGDEN PLLC, 2000 PNC PLAZA, 500 WEST JEFFERSON STREET, LOUISVILLE, KY, 40202-2828, US

(73) Assignee: Vianix Delaware, LLC, Virginia Beach, VA (US)

(21) Appl. No.: 12/136,596

(22) Filed: Jun. 10, 2008

(51) Int. Cl. G06F 15/16

(52) U.S. Cl. 709/205

(57) ABSTRACT

A signaling and media protocol for multi-channel recording using a client and a server is provided comprising an IP data network, a recording application on a client device, a signaling server and a media server. A method for signaling and media protocol for multi-channel recording is provided having a message type, the message type comprising means for command/response sequences being command and acknowledgement performed in the steps of Start Recording/acknowledge start recording, Current Recording/acknowledge current recording, Stop Recording/acknowledge stop recording. The method further comprises the steps of command/response sequences selectably performed in any order, as desired, of: Received Recording/acknowledge received recording, Mark Recording/acknowledge mark recording, Insert Recording/acknowledge insert recording, Noisy Recording/acknowledge noisy recording, Dropped Recording/acknowledge dropped recording, followed by Delete Recording/acknowledge delete recording.

### BRIEF DESCRIPTION OF THE DRAWINGS

FIG. 1 shows an embodiment for a signaling and media protocol for multi-channel recording wherein signaling and media are on two separate physical paths to two different servers.

FIG. 2 shows an embodiment for a signaling and media protocol for multi-channel recording wherein signaling and media are on two separate physical paths to one physical server having both signaling and media server modules.

FIG. 3 shows an embodiment for a signaling and media protocol for multi-channel recording wherein signaling and media are on a single physical path to one physical server having both signaling and media server modules.

FIG. 4 shows an embodiment for a signaling and media protocol for multi-channel recording wherein signaling and media are on a single physical path to a router, which routes the signaling and media independently to a signaling server and to a media server, respectively.

FIG. 5a shows an embodiment for a message structure of a signaling and media protocol for multi-channel recording.

FIG. 5b shows an embodiment for an acknowledgement structure of a signaling and media protocol for multi-channel recording.

FIG. 6a shows an embodiment for a header structure of a signaling and media protocol for multi-channel recording.

FIG. 6b shows an embodiment for an information field of variable length of a signaling and media protocol for multi-channel recording.

FIG. 7 shows embodiments for mode types of a signaling and media protocol for multi-channel recording.

FIG. 8a shows an embodiment for a signaling and media protocol for multi-channel recording having splitting and assembly of audio chunks over IP before encoding or after decoding.

FIG. 8b shows an embodiment for a signaling and media protocol for multi-channel recording having splitting and assembly of audio chunks over IP after encoding or before decoding.

FIG. 8c shows an embodiment for a signaling and media protocol for multi-channel recording having splitting and assembly of audio chunks over IP without encoding/decoding.

### MULTIPLE EMBODIMENTS AND ALTERNATIVES

Multiple embodiments of a System and Method For Signaling And Media Protocol For Multi-Channel Recording 10 are provided wherein a signaling and media structure is used to transmit and store recordings, to include recordings of phone conversations/dictations, involving two or more channels on one or more servers.

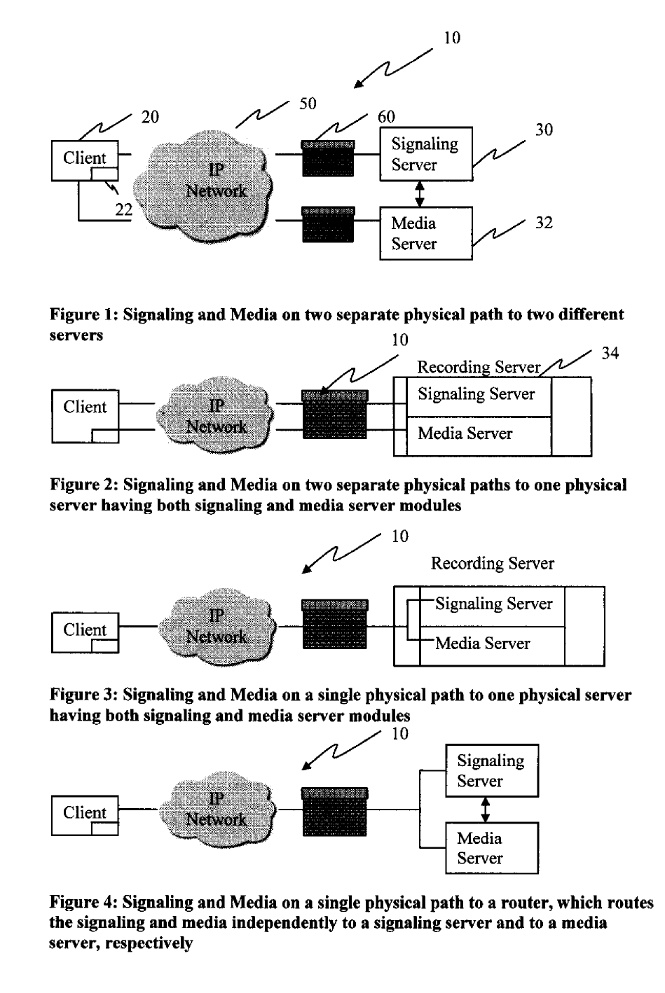

Referring to FIG. 1, an embodiment of a System For Signaling And Media Protocol For Multi-Channel Recording 10, and in particular, a messaging structure 100 is illustrated for a two channel recording using a recording application 22. The signaling and media structure is used to transmit and store the recordings of involving two or more channels on one or more servers. The recording application 22 is any software/hardware that is capable of recording voice signals from a variety of sources to include a user's client device. The client device is selectably or inclusively any of the standard current or contemplated cell phones, PDA's, PDA-Phones, smart phones, or the like. In one embodiment, the recording application 22 utilized is PocketTalk™, a system developed and marketed by Vianix®. The entire system 10 consists of a client device 20 and one or more servers such as, for example, a signaling server 30 and a media server 32 to receive signaling data, such as, for example, message structure 100 and media data such as, for example, audio data 40 from the recording application 22. An embodiment provides that the recording is done in three modes 220: auto-mode 222, on-demand-mode 222, and tape-recorder-mode 226.

In the auto-mode 222, as soon as a phone call comes in or dialed out, duplex channels are recorded automatically started using the recording application 22. The user is not given any indication that the call is being recorded.

In the on-demand mode 224, the server requests the client to turn ON the recording for the duplex channels.

In the tape-recorder mode 226, only a half-duplex or single channel on which the recording application 22 is running is placed into the recording mode. This is basic dictation into one device, but the data is stored on same server 30, 32 as above.

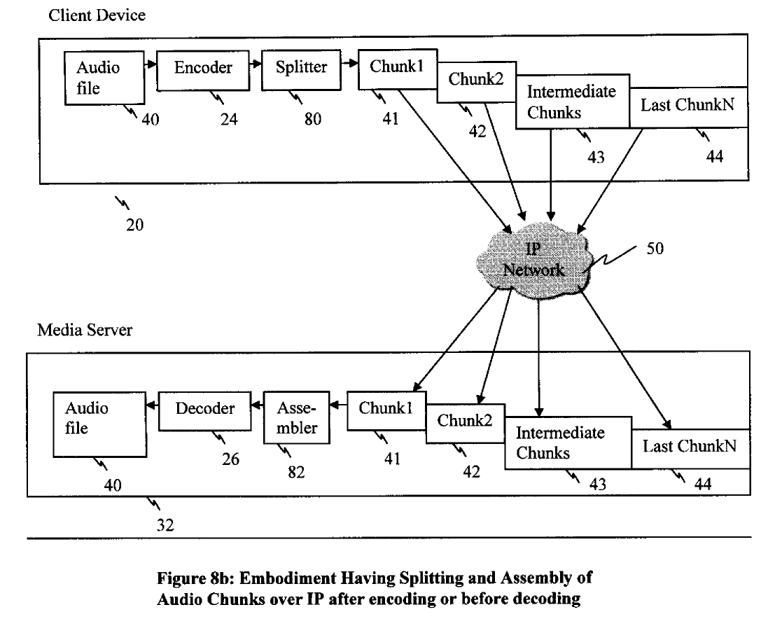

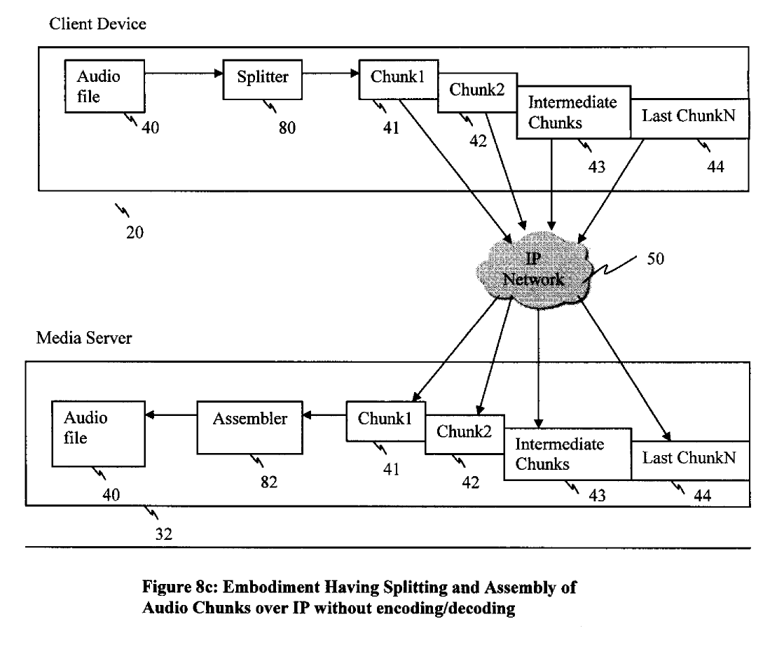

The media data, such as, for example, audio data 40 is captured from the recording application 22 on the client device 20 and compressed using any encoder 24 such as, for example, MASC® technology as described in U.S. patent application Ser. No. 10/676,491. Referring to FIGS. 8a-8c, the audio data 40 is sent in chunks 41 or streams. Embodiments exist wherein there is an initial chunk 41, one or more intermediate chunks 43, and a last chunk 44. In particular as an example meant to be non-limiting, and with continued reference to FIGS. 8a-8c, illustrated are Chunk 1, 41, chunk 2, 42, intermediate chunks 43, and a last chunk 44. Each of the chunks has a selectably chosen fixed time period, such as, for example 30 seconds, 1-min, 2-min, etc. The optimal size of the individual chunks 41-44 is programmed or found based on the usual duration of the recording/call. There is no requirement that all the chunks have the same fixed time period. In fact, embodiments exist wherein, for example, on a 33 second recording, the last chunk has a time period of 3 seconds.

With reference to FIG. 8a, an audio file 40 passes through an encoder 24 for compression, then through a splitter 80 which creates chunks 41-44. Those compressed chunks 41-44 are sent across an IP network 50. Once received by the media server 32, the compressed chunks 41-44 are decoded into uncompressed chunks 41-44 using an appropriate decoder 26, and then those uncompressed chunks 41-44 are reassembled by the Assembler 82 to form a complete audio data file 40. In further detail, an embodiment of the system for signaling and media protocol for multi-channel recording 10 utilizes an encoder 24 to compress a single audio file 40 thereby yielding a compressed audio file 40, followed by a splitter 80 to split the compressed audio file 40, yielding multiple compressed chunks 41-44, before the compressed chunks 41-44 are transmitted over the IP network 50, followed by assembly of the compressed chunks 41-44 into a single compressed audio file 40 using an assembler 82 after receipt from the IP network 50, thereby yielding a single compressed audio file 40, followed by decoding the compressed audio file 40 using a decoder 26, thereby yielding a single decompressed audio file 40.

With reference to FIG. 8b, an entire conversation is recorded on the client device 20, and then the splitter 80 creates chunks 41-44 which are passed through the encoder 24 and then sent across the IP network 50. Once received by the media server 32, the still-encoded chunks 41-44 are sent to an assembler 82 to be reassembled from chunks into an entire recording. That entire recording is sent through a decoder 26 and the output is audio data 40. In further detail, an embodiment of the system for signaling and media protocol for multi-channel recording 10 utilizes the splitter 80 to split an audio file 40 into multiple chunks 41-44 and encoding each chunk 41-44, thereby yielding compressed chunks 41-44, using an encoder 24 before the compressed chunks 41-44 are transmitted over the IP network 50, followed by decoding each compressed chunk 41-44 using a decoder 26 after receipt from the IP network 50, thereby yielding decompressed chunks 41-44, followed by assembly of the decompressed chunks 41-44 into a single audio file 40 using the assembler 82.

With reference to FIG. 8c, illustrated is an embodiment wherein neither an encoder 24 nor a decoder 26 is used. A client device sends an uncompressed audio data file 40 through a splitter 80 which creates chunks 41-44 which are in turn sent across the IP network 50. The media server 32 receives the uncompressed chunks 41-44 from the IP network 50 and sends those chunks 41-44 to the assembler 82 which reassembles the chunks 41-44 into a completed audio data file 40. In further detail, an embodiment of the system for signaling and media protocol for multi-channel recording 10 utilizes the splitter 80 to split an uncompressed audio file 40 into multiple chunks 41-44 and transmitting the chunks 41-44 over the IP network 50, followed by receipt of the uncompressed chunks 41-44 from the IP network 50, followed by assembly of the uncompressed chunks 41-44 into a single audio file 40 using the Assembler 82.

The message structure 100 and the audio data 40 are sent by two different asynchronous transmission methods. Again, U.S. patent application Ser. No. 10/676,491 is illustrative of this point by reference to its figures and as such, is incorporated by reference herein. Such transfer methods include e-mail, FTP and the like. Embodiments include the signaling server 30 and the media server 32 being physically or functionally incorporated together on one physical device such as, for example, a recording server 34. Alternatively, the servers 30, 32 are physically separate. For the servers 34 or 30, 32 to have either synchronous or asynchronous communication, the actual signaling message is sent along with the audio attachment on the e-mails, or even on the subject/body of the e-mail itself. Such embodiments are provided as especially useful in cases where the signaling and media are on two different servers residing across a firewall.

An embodiment includes signaling and audio on separate paths comprising separate physical audio data 40 channels. In this embodiment, the recording of audio is performed through a single medium such as, for example, e-mail, FTP, TCP/UDP, RTP over UDP, Peer-to-Peer (PTP) and the like. With reference to FIGS. 1-4, there are four possibilities with respect to paths and servers. They are: same physical path or different physical path; same physical server 34, or independent physical server 30, 32. The signaling on separate data is performed with the message structure 100 as below with reference to an associated relevant FIGURE. For embodiments having both channels on independent physical servers 30, 32, see FIG. 1. For embodiments having both channels on the same physical server, being a recording server 34, see FIG. 2. For embodiments having the message structure 100 and the audio data 40 on the same physical path to a single physical server, being a recording server 34, see FIG. 3. With particular reference to FIG. 4, embodiments for which the same physical path is desired along with the use of independent servers 30, 32, a router 60 is required. In particular, with continued reference to FIG. 4, both the message structure 100 and the audio data 40 are sent to separate servers 30, 32 for processing after being received by the router 60. With overall reference to FIGS. 1-4 and to the descriptions above, each of the embodiments described above is provided in alternative embodiments wherein one, both or neither of router and firewall are included. Furthermore and as desired, for embodiments having physically separate servers, both the signaling server 30 and the media server 32 communicate with each other using the same messages from the client device 20 or some other messaging scheme.

Embodiments are provided wherein the message structure 100 and audio data 40 are sent using different channels. In addition, an embodiment is provided wherein audio data 40 is on e-mail and message structure 100 is on a separate channel.

The message structure 100 is duplicated in a byte format or in standard ASCII or Unicode Text on the Subject or Message body of the e-mail which is further duplicated, as desired, for fault tolerant purposes or messaging behind the servers. Embodiments are provided wherein this is done similarly on FTP servers. When using TCP or UDP, an embodiment provides that the message structure 100 is sent through TCP and the audio over UDP or RTP/UDP.

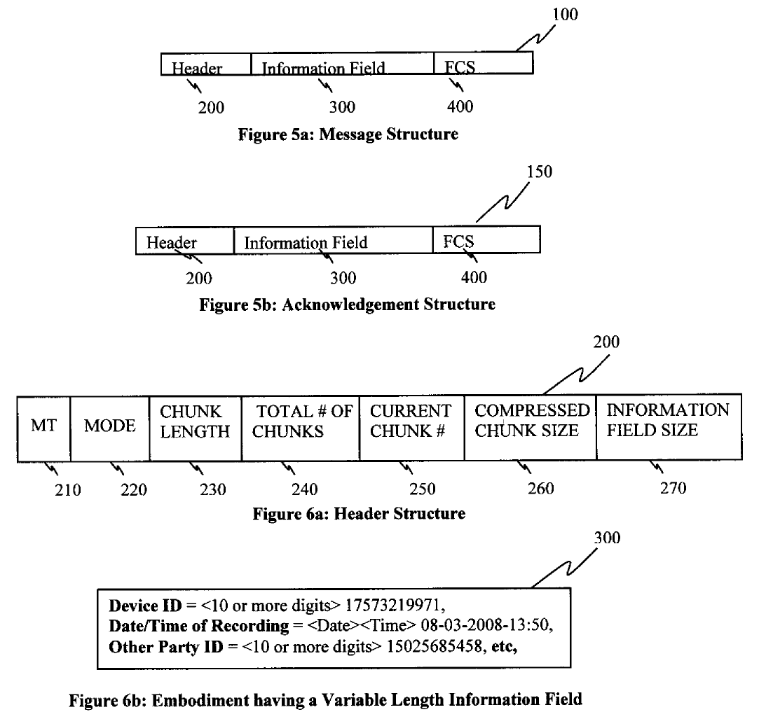

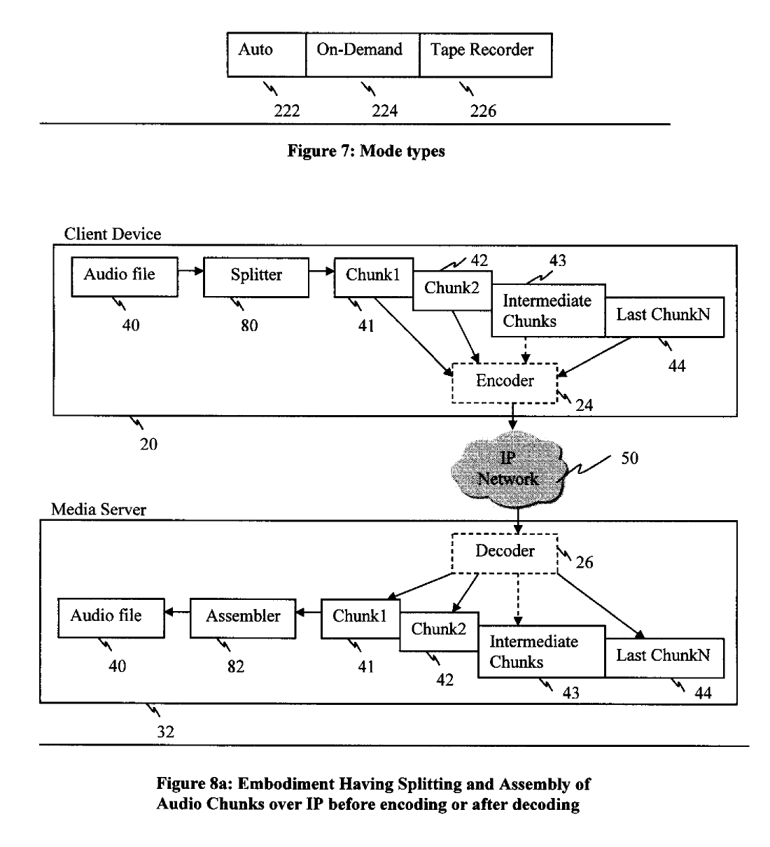

The MESSAGE STRUCTURE (MS) 100 is comprised of elements as shown in FIG. 5. It consists of the following:
1. The header 200 which is further comprised of specified sub-elements as shown in FIG. 6, and detailed further below.
2. The information field 300 which consists of unique ID means, such as, for example, telephone number (Device ID) and start time of recording (Recording ID).
3. The frame check sequence 400 is a Cyclic Redundancy Code (CRC) that is used to confirm that the message packet has been transmitted accurately and with no errors.
   The header 200 consists of the following sub-elements with a structure as illustrated in FIG. 6 wherein embodiments provide all sub-elements of the header 200 provided in bits, and other embodiments provide for a byte-sized boundary in cases where the bits do not require optimization. All of the characters or byte-sizes are provided in ASCII or Unicode, as desired.

The sub-elements are described in further detail below:
MESSAGE TYPE (MT) 210: With respect to this sub-element, US means upstream and in particular, from the client device 20 to the server 34 or 30, 32. DS means downstream and in particular, from the server 34 or 30, 32 to the client device 20. Embodiments exist wherein the message type 210 is provided in command/response means, such as, for example, the following 5 forms:
1. Start Recording (US): An indication is made from the client device 20 to the server 34 or 32, 30 in informing “Start of Recording”
2. Current Recording (US): An indication is made from the client device 20 to the server 34 or 32, 30 in informing “Middle of Recording”
3. Stop Recording (US): An indication is made from the client device 20 to the server 34 or 32, 30 in informing “End of Recording”
4. Received Recording (US): A request is made from the client device 20 to the server 34 or 32, 30 in making an inquiry that means “Have you received?”
5. Delete Recording (US). A request is made from the client device 20 to the server 34 or 32, 30 in making an inquiry that means “May I delete?”

Other embodiments provide that the “Received Recording” and the “Delete Recording” are indications from the server instead of a request from the client.

Other embodiments are provided that utilize these further forms either US or DS:
6. Mark Recording
7. Insert Recording
8. Noisy Recording
9. Dropped Recording

Embodiments exist wherein the range of forms is even greater. An embodiment provides that 6 bits are dedicated for message type 210 resulting in a total of 64 messages in all.
MODE 220: An embodiment provides a mode designation means such as, for example, the mode 220 in 2 or 3 bits in the form of:
0 (2 bits: 00, 3 bits: 000) means auto mode 222
1 (2 bits: 01, 3 bits: 001) means on-demand mode 224
2 (2 bits: 10, 3 bits 010) means tape recorder mode 226
3 (2 bits: 11, 3 bits 011) means a NACK (Not Acknowledged) message for a variety of reasons such as Unknown Error, FCS-Incorrect, network unreachable, server unreachable, channel error, noisy recording, clipped recording, and the like.
CHUNK LENGTH 230: An embodiment provides the chunk length 230 in 2 or 3 bits and means for chunk length designation. Chunk length 230 is provided in any multiples of seconds, minutes or hours, as desired. For an example using 30 second chunks, a corresponding form is as follows:
0 (2 bits: 00, 3 bits: 000) means 30 Seconds
1 (2 bits: 01, 3 bits: 001) means 60 seconds (one minute)
2 (2 bits: 10, 3 bits: 010) means 90 seconds
3 (2 bits: 11, 3 bits: 011) means 120 seconds (two minutes)
4 (3 bits 100) means 150 seconds (two and a half minutes) and so on.

TOTAL # OF CHUNKS 240: This is provided in 2 Octets wherein an Octet=an 8-bit byte. Because 1 Octet would only provide 2 hours maximum, embodiments provide 2 Octets which actually give 2̂16 chunks, thereby equating to one or more days of duration.

CURRENT CHUNK # 250: The current recording chunk number out of a possible total number of chunks. This cannot be more than TOTAL # OF CHUNKS 240. The value is provided in a range from 0 up to and including the value for [(TOTAL # OF CHUNKS 240) minus one].

COMPRESSED CHUNK SIZE 260: is the size in bytes of the current compressed chunk.

INFORMATION FIELD SIZE 270: contains the length of the INFORMATION FIELD 300 in bytes.

INFORMATION FIELD 300: This field consists of means for expressing attributes provided in unique character format. Embodiments include means having formats, such as, for example, null separated values (NSV), escape separated values (ESV) and comma separated values (CSV) and the like. Referring to FIG. 6b, an example is provided, not meant to be limiting, of an embodiment having an information field 300 that includes attributes including unique ID means such as the Device ID being, for example, the telephone number of either the Device 20 or the Other Party as desired. Other examples of unique ID means for the Device ID include SIM code, PIN code, MAC ID, user name, and any other combination of characters forming a means of identification such as to be unique to the Device 20. Also in the information field 300 are, as desired, recording ID means which provide details regarding the physical characteristics of the recording of either or both of outgoing or incoming calls of the device 20. Additionally, recording ID means include the Date/Time of Recording and other information, such as the device ID, based on what is required to identify the call or recording uniquely. An example is the Caller ID provided in a CSV format.

Another example of recording ID means is as follows: For a recording, multiple chunks 41-44 are indexed as desired in the form of the recording ID means being a reference number. To further illustrate this example, the reference number is formed by concatenating the unique device ID means and the recording ID means. For example, the unique device ID is the telephone number which is concatenated with the recording ID means being start time of the call, thereby producing an index to that recording in the form of “<Reference Number> 1 of 20”, for an example having 20 chunks 41-44. In such cases, the total duration is represented by the total number of chunks 240. If a recording chunk is missed out, that chunk 41-44 is retransmitted based on the acknowledgement from the server 34 or 30, 32.

The Information field 300 is of variable size and extendable with other parameters other than Start Time of the recording which is Date and Time in numerical number, such as, for example, from Jan. 1, 1970 or the like. Date and Time is included in the information field 300 as desired, as is the telephone number discussed above. Additionally, a 1-Octet message type 210 is selectably included, as desired, in the Information field 300. Alternatively, the message type 210 is provided in 6-bits and is moved into the header 200, and 2 bits are provided for the mode 220.

By way of further example, an embodiment provides that the information field 300 includes the following:
Device ID must be included as a unique ID means such as, for example, the telephone number of the Device 20—at least 10 or more if using international numbers, digits, with a size of, for example, 5 bytes.
Date/Time of recording must be included as a recording ID means with a size of, for example, 8 bytes.
Other Party ID is selectably included, as desired, as a unique ID means such as, for example, the telephone Number of the other party—at least 10 and even more if using international numbers, digits, with a size of, for example, 5 bytes.
The information field further contains, as desired, other fields such as file name, or place-holding data relevant to any of the recording, the user, the company, and the like.

FRAME CHECK SEQUENCE (FCS) 400: This is a CRC message (usually a 2-Octet CRC) to make sure at the receiver that the message received is not corrupted by transmission. This is particularly required in cases wherein wireless networks are used because of OTA (over the air) transmission issues. Note that a Coding Theory person would say “CRC” and that an Information Theory or Computer Science person would say “CHECKSUM.” For the purposes of these teachings, CRC and CHECKSUM are intended to be synonymous, yet CRC is the term chosen here. By way of example and with reference to FIGS. 5a and 5b, the FCS 400 is run through header 200 and its information field 300 where bit (meaning binary) operations such as, for example, XOR are performed. The output from such an operation has a size of 2 bytes. If the output matches the 2 bytes of the FCS 400 during reception of the audio signal 40, then the result is that no data corruption occurred in the process of communications over an IP network 50.

ACKNOWLEDGEMENT STRUCTURE (AS) 150 The purpose here is to have the server 34 or 30, 32 inform the client device 20 that that it received the chunk 41-44 and to indicate that the client device 20 delete that chunk 41-44 from the device 20. The elements of the AS 150 are the same as those found in message structure 100. However, the functionalities and purpose are distinct in that the AS 150 is transmitted back to the client device 20 in order to confirm a lack of corruption and, in some embodiments, to set new values for sub-elements within the header 200. For example, the mode 220 may be switched, as desired, from auto mode 222 to tape recorder mode 226. In cases where signaling and media are delivered sequentially, and assuming that the delivery occurred with no errors, then the AS 150 is not required. However, other cases exist and embodiments are also provided wherein the signaling and media are delivered asynchronously and in such cases, the information field 300 is required. With reference once more to Mode 220, the mode 220 bits are selectably utilized, as desired, in order to request that the client device 20 perform multiple functions as desired.

For example, the telephone number is selectably left out of the information field 300, which is itself selectably left out of the AS 150. Such embodiments are useful when sending one recording at a time. Other cases exist wherein there are no responses and in such cases the device 20 is instructed to keep sending the following recordings (chunks 41-44) anyway. A problem may arise in that for the first recording sent, if the AS 150 acknowledges back later, after the second recording was sent, then the client device 20 may not be able to distinguish the acknowledgement from the AS 150 was a response for the first or the second recording from the client device 20. In such cases, it is useful to add a sequence number to the MS 100 in order that the AS 150 may be able to distinguish each acknowledgement for the client device 20.

By way of examples not meant to be limiting, the following illustrative points apply:

In cases where it is not desired that a client device open and monitor its TCP/IP port, the US (Upstream, client-to-server communication) protocol with the first 5 message types 120 is utilized. Additional command/response sequences are intended to allow for DS (Downstream, server-to-client) messages.

In cases where the client-to-server communication is a many-to-one scenario: The US commands are always client initiated, Master commands. The DS responses are always a server's “acknowledgement” and are therefore Slave responses. These slave responses must contain the unique device ID means in the Command/Sequence and not merely in the info field 300, so that both the client device 20 and the server 34 or 30, 32 can act rapidly. For example, in the event that, for some reason, the response is for another client, the client device 20 is not required to take any action. Except for cases where a network 50 or server becomes bogged down, the command/response sequence is swift and efficient. In the event of complete network 50 failure, and from both a diagnostic and recovery procedure point of view, whatever is stored in the client device 20 is sent across the network 50 upon its return to operations. The device 20 removes all recordings which were not acknowledged by the server 34 or 30, 32. In cases where the client device 20 does not receive a proper response, it initiates a retry later within selectable timeframe of milliseconds to minutes, as desired. When the server 34 or 30, 32 reads a command on its port, if the client device 20 id is not valid, for example, not matched in its database, or simply garbled gibberish, it will reject or ignore it. The device 20 retains the affected chunk 41-44 in memory until it can transmit the chunk 41-44 again. In such cases, the AS 150 is changed to reflect a value (for example, bits 11) meaning “NACK” or “No ACKnowledgement” for MODE 220.

Embodiments include client devices 20 being mobile, and having recording features to include:

The On-Demand mode 224 as previously discussed and wherein the client device 20 is set to behave in an on-demand mode. For example, the device 20 has control of whether to record, pause or forgo recording. As such, the device 20 performs a set of tape recording functions, except that the device is utilized for telephone conversation and not limited to dictation.

The auto-recording mode 222 wherein the client device is set to record all calls.

The tape recorder mode 226 wherein the device 20 is set to operate in a conventional dictation mode, using the client device 20 as a dictation device, such as, for example, a tape recorder.

Embodiments provide that all recordings are transferred to server 34 or 30, 32.

Embodiments also provide that the transport mechanism is through email. For example, after a recording is completed by a client device 20, it is emailed to the server 34 or 30, 32. The server 34 or 30, 32 extracts the attachment from the email and stores it in an appropriate disk folder for processing. At this point, the server 34 or 30, 32 determines the originator of the recording by receipt of the email and the timestamp, wherein both of these values are set in the information field 300. The server 34 or 30, 32 also determines the size of the recording by reference to the Compressed Chunk Size 260 which is part of the header 200.

Embodiments provide that the recording is made in the MASC® propriety format and it is stored as such.

With further detail as to the first 5 forms of message type 210, examples of Command/Response Sequences to deal with the above features are as follows:

1. The DTMF may be used, as desired, as a start recording command to the server. At any start up (power up) of a client device 20, the device 20 may send a start recording command to the server 34 or 30, 32 as:
a. Command: Start Recording: {Header=<MT=Start Recording, Mode=0, Chunk Length=30-sec, Total # of Chunks=40, current chunk#=0, Compressed Chunk Size=44 bytes>, Information Field=<device id=1757 321 9971, start time of recording=date/time=06-06-2008-15:32:44, other party id=1502 568 5458, any other information > <FCS=2-bytes>}. The device id is, for example, the telephone #, but can also be the device's MAC Address or any id that uniquely characterizes the device.
b. Response: Acknowledge Start Recording, same as above if the ACK is fine, otherwise means for mode designation allows setting of the mode to a bit value of 11, as desired, or to other bit values other than what came across in the command (which in the example above was bits 00, auto mode 222) and representing any of Auto (for example 00), On-Demand (for example 01) or Tape-Recorder (for example 10), as desired.

2. At any time the recording has been emailed to the server:
a. Command: Current Recording, (Header=<MT=Current Recording, Mode=0, Chunk Length=30-sec, Total # of Chunks=40, current chunk#=1, Compressed Chunk Size=44 bytes>, Information Field=<device id=1757 321 9971, start time of recording=date/time=06-06-2008-15:32:44, other party id=1502 568 5458, any other information > <FCS=2-bytes>}. Current Recording includes unique device ID means, and any other desired additional information, such as, for example, chunks 42, 43 after the first and before the last, for instance, the current chunk # 250 of the recording. Other embodiments include this in the actual command for enhanced efficiency.
b. Response: Acknowledge Current Recording, same as above if the ACK is fine, otherwise means for mode designation allows setting of the mode to a bit value of 11, as desired, or to other bit values other than what came across in the command (which in the example above was bits 00, auto mode 222) and representing any of Auto (for example 00), On-Demand (for example 01) or Tape-Recorder (for example 10), as desired. If, for any reason, the Response is not forthcoming, the device 20, as desired, is configured to retry later up to a specified number of retries. In general, before getting a positive acknowledgement from the server 34 or 30, 32, the device 20 does not delete the recording. For example, if the call memory on the device 20 becomes full in such cases, and then the client device 20 receives an additional incoming call, the device 20 records, as desired, over existing memory if all the chunks 41-44 of the previous call were not completely transferred to the server 34 or 30, 32.

In situations when the client device 20 must stack the consecutive recordings for multiple calls, the length of calls permitted will depend on the size of recording. As desired, a wait period for a retry is progressively longer until retries are ended at a selectably chosen number of retries. In such instances, a contingency procedure is provided as follows on how to handle such a total lack of acknowledgement: The device 20 may take any of several procedures such as, for example, delete the recording, store it for specified period of time, or store the recording until a new call comes in.

3. At the end of any call, the device 20 may send a stop recording command to the server 34 or 30, 32. Embodiments include those wherein the call hang-up itself serves as the stop recording command. In other embodiments, the stop recording command is sent as follows:
a. Command: Stop Recording, {Header=<MT=Stop Recording, Mode=0, Chunk Length=30-sec, Total # of Chunks=40, current chunk#=39, Compressed Chunk Size=44 bytes>, Information Field=<device id=1757 321 9971, start time of recording=date/time=06-06-2008-15:32:44, other party id=1502 568 5458, any other information > <FCS=2-bytes>}.
b. Response: Acknowledge Stop Recording, same as above if the ACK is fine, otherwise means for mode designation allows setting of the mode to a bit value of 11, as desired, or to other bit values other than what came across in the command (which in the example above was bits 00, auto mode 222) and representing any of Auto (for example 00), On-Demand (for example 01) or Tape-Recorder (for example 10), as desired.

4. A command string is provided in order to confirm that the server 34 or 30, 32 is in service, in order to ensure that the server 34 or 30, 32 has already received the recording. If not, it will stack the recording.
a. Command: Receive Recording, {Header=<MT=Receive Recording, Mode=0, Chunk Length=30-sec, Total # of Chunks=40, current chunk#=25 (any value between 0 and 39), Compressed Chunk Size=44 bytes>, Information Field=<device id=1757 321 9971, start time of recording=date/time=06-06-2008-15:32:44, other party id=1502 568 5458, any other information > <FCS=2-bytes>).
b. Response: Acknowledge Receive Recording, same as above if the ACK is fine, otherwise means for mode designation allows setting of the mode to a bit value of 11, as desired, or to other bit values other than what came across in the command (which in the example above was bits 00, auto mode 222) and representing any of Auto (for example 00), On-Demand (for example 01) or Tape-Recorder (for example 10), as desired.

5. A command string is provided in order to delete the recording on the device 20 as an acknowledgement from the server 34 or 30, 32.
a. Command: Delete Recording, {Header=<MT=Delete Recording, Mode=0, Chunk Length=30-sec, Total # of Chunks=40, current chunk#=25 (any value between 0 and 39), Compressed Chunk Size=44 bytes>, Information Field=<device id=1757 321 9971, start time of recording=date/time=06-06-2008-15:32:44, other party id=1502 568 5458, any other information > <FCS=2-bytes>}.
b. Response. Acknowledge Delete Recording, same as above if the ACK is fine, otherwise means for mode designation allows setting of the mode to a bit value of 11, as desired, or to other bit values other than what came across in the command (which in the example above was bits 00, auto mode 222) and representing any of Auto (for example 00), On-Demand (for example 01) or Tape-Recorder (for example 10), as desired.

Embodiments provide that, as desired, the system allows the server 34 or 30, 32 to use AS 150 in order set a change in the mode designation means, such as, for example, the mode 220 found within the header 200 of the device 20 for the recording application 22. In such embodiments, the server 34 or 30, 32 utilizes the header 200 of the AS 150. For example, the AS 150 is selectably set, as desired, to change the mode designation means, such as, for example, the mode 220 from on-demand mode 224 (for example, bits 01) to auto mode 222 (for example, bits 00) or vice-versa. To further illustrate this point, several options are provided:
a. Option 1: In every command, the client device 20 sends the mode 220 in the header 200 of the AS 150.
b. Option 2: At the start of every recording, the client device 20 sends a start recording command indicating what mode 220 it is in. The server 34 or 30, 32 selectably changes, as desired, the value of the mode 220 in the corresponding acknowledge start recording AS 150 command to set a new value in the mode 220 of the header 200.
c. Option 3: At the end of every recording, the client device 20 sends a stop recording command indicating what mode 220 it is in. The server 34 or 30, 32 selectably changes, as desired, the value of the mode 220 in the corresponding acknowledge stop recording AS 150 command to set a new value in the mode 220 of the header 200.

An embodiment provides an initial installation as follows:
a. Download Recording Application 22 to the client device 20 from the server 34 or 30, 32 by means such as, for example, wireless Over The Air (OTA) or a wired IP network 50, and,
b. Set up manually, or download, the initial client configuration, user, recording mode 220 and other values as desired by the installer or the administrator on the server 34 or 30, 32, such as, for example in creating or modifying a user profile and using means such as, for example, Operation or Business Support System (OSS or BSS) software or any software that uses XML Configuration Access Protocol (XCAP).

Embodiments are provided having Live Monitoring, defined herein as that instead of using the chunks 41-44 as described above, the system and method 10 allows for a “stream” of the compressed signal from the device 20. In such embodiments, the device 20 begins to send almost immediately, with only a minimal delay in the range of only milliseconds up to a few seconds, and the device 20 selectably, as desired, sends parts of, or even, the entire conversation as a continuous transmission or “stream.” Such cases are especially useful where supervisors wish to perform live monitoring of the calls of their subordinates. For these embodiments, the email system may not be the most efficient and instead, the system 10 utilizes Real-time Transmission Protocol (RTP) over User Datagram Protocol (UDP) streams, as desired.

Various usage scenarios are outlined as follows.

1. Always-on Normal Operation

By use of OTA wireless data channel (per a user's cell phone subscription plan), Wi-Fi (IEEE 802.11a\b\g), a wired data channel, or a wired IP network 50, the user, who is configured for always-on recording, leaves their cell phone turned on all of the time by recharging in their adaptor overnight. They make a lot of calls while driving and get cut off at times when they drive through cellular dead zones. When the user “docks” his phone with his PC, the ActivSync program (if running MS Windows Mobile) or similar synchronization stores and forwards the call recordings to the server 34 or 30, 32. Of the choices for Mode 220, this scenario illustrates Auto Mode 222 (for example, bits 00), but other modes 220 may also be selected as desired.

2. On-Demand Normal Operation

This is a special case and it works as per 1. above, but the user initiates action to record certain calls as desired. The user doesn't always know if he wants to record a call until part way into it and he wants to capture the next call. Of the choices for mode designation means for Mode 220, this scenario illustrates On Demand Mode 224 (for example, bits 01), but other modes 220 may also be selected as desired.

3. Tape Recorder Mode

They also want to be able to dictate notes using their phone that they can email to others rather than calling each person to leave a voicemail. Of the choices for mode designation means for Mode 220, this scenario illustrates dictation mode 226 (for example, bits 10).

4. Normal Operation with Power On/Off

This user is the same as (1) or (2) but they turn off their phone while they are in meetings and overnight. They often finish a call just before a meeting and turn off the phone as soon as the call is over. The call sometimes ends prematurely as they go into a meeting room without cell coverage and they turn off the phone. Any resulting saved chunk is sent out once the phone is powered back on and acquires an access to the IP network 50.

5. Server Outage

The server 34 or 30, 32 is normally operational 24 hours a day and 7 days a week, but may be taken offline for scheduled maintenance without notification to the phone users. Also, unplanned outages can occur if the server 34 or 30, 32 crashes or a hard disk fails that may leave the server offline for a day or more. This can be handled using redundancy based on 1+1 (One server with 1 backup), N+1 (Multiple server with one dedicated as proxy), or N+M (Multiple servers with additional servers as backup/proxy) models. For example, in an embodiment, one server handles 300 users and there are 1500 users total. For this embodiment, the N+1 model is selected. 5 servers are chosen, as desired, plus an additional server for backup.

6. Email Disruption/Loss

The email server collects the emails and forwards them to the server. The email server may get overloaded with other messages that cause it to delay forwarding the emails to the server for a few hours. The email server could also crash and lose some of the emails that are in transition to the server 34 or 30, 32. Such cases of email disruption/loss are dealt with utilizing standard network administration procedures.

7. Communication Disruption

The firewall settings or router or other element in the communications network could be disrupted causing the lower level port access to become unavailable (ports are used in pairs i.e. Port 8800 and Port 5060) for a period of time that could stretch out to hours or days until the problem is resolved. Cases of communication disruption are dealt with utilizing standard network administration procedures such as routing to a different network or to a different TCP/IP port.

8. Phone Loss/Theft

The user may lose their phone or have it stolen. One embodiment utilizes a (DS) command to set the suspected phone to the auto mode 222 and allow it to record conversations for a period sufficient to gather evidence for an internal or even a criminal investigation. The person that tries to use the lost or stolen phone has their calls recorded and the recordings are transferred to the server 34 or 30, 32. These recordings on the server 34 or 30, 32 used, as desired, to track the user and to deny that user access to further phone conversations. Once sufficient conversations are so recorded, the phone is disabled, as desired, in cooperation with the phone carrier network.

9. Shared Use of Phone

Shared use brings up the problem of concurrent users. Some companies have designated phones for use by more than one person. In such cases, company management may desire that not only are conversations recorded on these phones, but also, that those conversations are indexed to each particular user of the device 20. In such cases, there are many ways to identify the user, such as, for example, use of the OSS/BSS system information wherein the user identification is performed by pushing from the server 34 or 30, 32 into the device 20, or in cases where that information cannot be retained in the cell phone or device 20 itself by programming the device 20. An example of device 20 programming is having each unique user press a key or series of keys before taking or placing a call.

10. Roaming

Roaming charges are very expensive and customers will want to avoid them. As desired, a user toggles a flag in Recording Application 22 to halt the transfer of the recordings until the user is back on their primary/home network. In an alternate embodiment, an IT Administrator is also able to use the network 50 to set the device 20 as above in order to avoid roaming costs. For embodiments wherein a cellular data modem (CDM) is used on the server 34 or 30, 32, that CDM is able to detect a roaming call and, as desired, auto-block the device 20 from further sending any messages to the server 34 or 30, 32, thereby avoiding roaming charges.

I claim:

1. A system for signaling and media protocol for multi-channel recording using a client and a server and comprising,
An IP data network,
A recording application,
A signaling server; and
A media server.

2. The system for signaling and media protocol for multi-channel recording of claim 1 further comprising the IP data network chosen from the group wireless or wired.

3. The system for signaling and media protocol for multi-channel recording of claim 1 further comprising, the signaling server receiving, processing and acknowledging the message information using a communication protocol selected from the group synchronous, asynchronous, to and from the recording application and (where separate) to and from the media server.

4. The system for signaling and media protocol for multi-channel recording of claim 1 further comprising, the media server receiving, processing and acknowledging the audio sent from the recording application.

5. The system for signaling and media protocol for multi-channel recording of claim 1 further comprising, any one of the group recording application, signaling server and media server acting as a master and the remaining two acting as a slave.

6. The system for signaling and media protocol for multi-channel recording of claim 1 further comprising, the recording application selected from the group software, firmware, hardware and further capable of recording voice signals from a client selected from the group mobile PDA, cell phone, laptop computer, smart phone and group fixed, wired laptop, desktop and server.

7. The system for signaling and media protocol for multi-channel recording of claim 6 further comprising the software and firmware together included in a PocketTalk™ application having MASC® technology.

8. The system for signaling and media protocol for multi-channel recording of claim 1, the recording application capturing audio in resolution selected from the group 8-bit, 16-bit and 32-bit, and sampling frequency selected from the group 8 KHz, 16 KHz, and in one-way or two-way communication, with either or both, of the signaling server and the media server.

9. The system for signaling and media protocol for multi-channel recording of claim 1, the signaling and media on paths selected from the group same, different, and the network selected from the group wireless, wired LAN.

10. The system for signaling and media protocol for multi-channel recording of claim 9, the audio selected from the group compressed, uncompressed and the communication selected from the group chunking, streaming.

11. The system for signaling and media protocol for multi-channel recording of claim 10, further comprising a splitter to split an uncompressed audio file into multiple chunks and transmitting the chunks over the IP network, followed by receipt of the uncompressed chunks from the IP network, followed by assembly of the uncompressed chunks into a single audio file using an Assembler.

12. The system for signaling and media protocol for multi-channel recording of claim 10, further comprising a splitter to split an audio file into multiple chunks and encoding each chunk, thereby yielding compressed chunks, using an encoder before the compressed chunks are transmitted over the IP network, followed by decoding each compressed chunk using a decoder after receipt from the IP network, thereby yielding decompressed chunks, followed by assembly of the decompressed chunks into a single audio file using an assembler.

13. The system for signaling and media protocol for multi-channel recording of claim 10, further comprising an encoder to compress a single audio file thereby yielding a compressed audio file, followed by a splitter to split the compressed audio file, yielding multiple compressed chunks, before the compressed chunks are transmitted over the IP network, followed by assembly of the compressed chunks into a single compressed audio file using an assembler after receipt from the IP network, thereby yielding a single compressed audio file, followed by decoding the compressed audio file using a decoder, thereby yielding a single decompressed audio file.

14. The system for signaling and media protocol for multi-channel recording of claim 10, the compressed chunks first being assembled by the media server thereby forming compressed chunks and secondly audio being decompressed yielding the audio file.

15. The system for signaling and media protocol for multi-channel recording of claim 1, the audio recording performed in modes selected from the group Automatic, on-demand, and tape-recorder.

16. The system for signaling and media protocol for multi-channel recording of claim 1, comprising a recording server including both the signaling server and the media server.

17. The system for signaling and media protocol for multi-channel recording of claim 10, the audio selected from the group e-mail, FTP, TCP/UDP RTP over UDP, PTP.

18. The system for signaling and media protocol for multi-channel recording of claim 1 further comprising the signaling server and the media server including firewall protection.

19. The system for signaling and media protocol for multi-channel recording of claim 18, comprising the message followed by the audio recording in the same protocol.

20. The system for signaling and media protocol for multi-channel recording of claim 19, comprising the message info being sent on one physical path and the audio recording being sent on a separate path.

21. A system for signaling and media protocol for multi-channel recording comprising a signaling message structure including a header, an information field, and a frame check sequence.

22. The system for signaling and media protocol for multi-channel recording of claim 21 the header further comprising:
A message type,
A mode,
A chunk length,
A total # of chunks,
A current chunk #,
A compressed chunk size; and,
An information field size.

23. The system for signaling and media protocol for multi-channel recording of claim 22 further comprising the message type and the mode each inserted within the information field of the message structure.

24. The system for signaling and media protocol for multi-channel recording of claim 22 further comprising the message type selected from the group Start Recording, Current Recording, Stop Recording, Received Recording, Delete Recording. Mark Recording, Insert Recording, Noisy Recording, Dropped Recording.

25. The system for signaling and media protocol for multi-channel recording of claim 22 further comprising the mode selected from the group automatic, on-demand, tape-recorder.

26. The system for signaling and media protocol for multi-channel recording of claim 21 further comprising an order of bytes switched in the message structure in any of the fields.

27. The system for signaling and media protocol for multi-channel recording of claim 21 further comprising the header, information field, and frame check sequence having field sizes as:
message type 5-bits,
mode 3-bits,
chunk length 2 octets,
total # of chunks 2 octets,
current chunk # 2 octets,
compressed chunk size 4 octets; and,
information field size 4 octets.

28. The system for signaling and media protocol for multi-channel recording of claim 21 further comprising the header, information field, and frame check sequence having field sizes as:
message type 6-bits,
mode 2-bits,
chunk length, 2 octets,
total # of chunks, 2 octets,
current chunk #, 2 octets,
compressed chunk size, 4 octets; and,
information field size, 4 octets.

29. The system for signaling and media protocol for multi-channel recording of claim 21 further comprising the header, information field, and frame check sequence having field sizes being in octet multiples of at least 1.

30. The system for signaling and media protocol for multi-channel recording of claim 21 further comprising the information field including a unique ID means.

31. The system for signaling and media protocol for multi-channel recording of claim 21 further comprising the information field including a unique Other Party ID.

32. The system for signaling and media protocol for multi-channel recording of claim 30 further comprising the unique ID means selected from the group MAC ID, log-in ID, mobile phone SIM card, and IMSI/TMSI.

33. The system for signaling and media protocol for multi-channel recording of claim 31 further comprising the Other Party ID selected from the group MAC ID, log-in ID, mobile phone SIM card, and IMSI/TMSI.

34. A method for signaling and media protocol for multi-channel recording having a message type, the message type comprising means for command/response sequences being command and acknowledgement performed in the steps of:
1. Start Recording/acknowledge start recording,
2. Current Recording/acknowledge current recording; and,
3. Stop Recording/acknowledge stop recording.

35. The method for signaling and media protocol for multi-channel recording of claim 34, the message type further comprising means for command/response sequences of.
4. Received Recording/acknowledge received recording,
5. Mark Recording/acknowledge mark recording,
6. Insert Recording/acknowledge insert recording,
7. Noisy Recording/acknowledge noisy recording,
8. Dropped Recording/acknowledge dropped recording
wherein steps 4 through 8 are selectably performed in any order; and,
9. Delete Recording/acknowledge delete recording.

36. The method of claim 35, further comprising the message type step being upstream and including the steps of.
1. A command having the message type is issued wherein:
a. a Header contains the fields:
1) MT,
2) Mode designation means,
3) Chunk Length being a selected time period,
4) Total # of Chunks being within a selected range,
5) Current chunk#,
6) Compressed Chunk Size being within a selected range,
7) Information Field Size,
b. an Information Field contains the fields:
1) unique ID means being device ID selected from the group telephone number, MAC ID, log-in ID, mobile phone SIM card, IMSI/TMSI,
2) recording ID means being start time of recording,
3) Other Party ID being a unique device ID means selected from the group telephone number, MAC ID, log-in ID, mobile phone SIM card, IMSI/TMSI,
4) reserved field for additional information,
c. an FCS being expressed in 2-bytes; and,
2. A Response of Acknowledgement for the Command is sent to the device wherein the Header fields are unchanged, thereby confirming that the command is acknowledged.

37. The method of claim 34, further comprising the response of Acknowledgement for the Command including a change in the mode designation means from and to values selected from the group auto, on demand, tape-recorder, NACK.

38. The method of claim 37, further comprising the NACK being a value selected from the group Unknown Error, FCS-Incorrect, network unreachable, server unreachable, channel error, noisy recording, clipped recording.
